(19) United States
(12) Patent Application Publication
(10) Pub. No.: US 2013/0073295 A1
(43) Pub. Date: Mar. 21, 2013

(54) AUDIO CODEC WITH VIBRATOR SUPPORT

(71) Applicant: Timothy M. Johnson, San Jose, CA (US)

(72) Inventor: Timothy M. Johnson, San Jose, CA (US)

(73) Assignee: Apple Inc., Cupertino, CA (US)

(21) Appl. No.: 13/238,462

(22) Filed: Sep. 21, 2011

(51) Int. Cl. G10L 19/00

(52) U.S. Cl. 704/500; 704/E19.001

(57) ABSTRACT

A dual channel audio coder decoder (codec) chip that has two output pins, which can be used to drive a pair of speakers in stereo mode, or a vibrator and a single speaker in mono mode. Each channel has its own DAC and audio power amplifier to receive an audio signal for driving a speaker. Each channel also has a variable signal generator to generate a vibrator signal for driving a vibrator. The DAC and variable signal generator outputs of each channel are input into a respective multiplexer. The multiplexer and the vibrator frequency are configured via an external digital communication interface. Other embodiments are also described.

### BACKGROUND

An embodiment of the invention generally relates to a multi-channel audio coder decoder (codec) integrated circuit chip that is capable of driving either a speaker and a vibrator simultaneously, or a pair of speakers simultaneously, through the same output pins. Other embodiments are also described.

Portable audio devices are used throughout society to play media, play games, place/receive phone calls, and various other actions that require the portable audio device to process digital audio. As portable audio devices become more immersed in user's everyday lives, there is a growing need for these devices to become smaller, thinner, and lighter. This move to increase portability is often in contrast with the desire to add more features and components to portable audio devices. Accordingly, the elements in portable audio devices should be used in an efficient manner such that space is conserved.

Additionally, portable audio devices are often provided in different varieties from the same designer/manufacturer. For example, Apple Inc. of Cupertino, Calif. designs the iPhone™, iPad™ and iPod™ portable audio devices. These devices process and output audio, but often include other components to perform non-audio tasks. For example, while the iPhone™ and iPod™ devices include a vibrator that is used for original message alerts to the user, the iPad™ device does not include a vibrator. The audio codec chip in the iPhone™ and iPod™ devices may include a dedicated signal channel to process a vibrator signal. However, using the same audio codec chip in the iPad™ device would be inefficient as the dedicated vibrator signal channel would not be used.

### SUMMARY

There is a need for an audio codec chip that can be used in both portable audio devices that include a vibrator and in audio devices that do not include a vibrator, without wasting a signal channel.

An embodiment of the invention is a multiple channel audio codec chip whose output pins can be “re-used”, for alternately driving either a pair of speakers or a speaker and a vibrator, in an audio device. Each of two channels in the audio codec chip can produce both an analog audio signal for driving a speaker and, alternately (one at a time, not both simultaneously), an analog vibrator signal for driving a vibrator. Each channel has a multiplexer with a first input that is coupled to receive an audio out signal from the output of a DAC, a second input that is coupled to the output of a variable signal generator, and a control input to receive a selection signal. The selection signal determines whether the channel is to be used for an audio signal or whether it is to be used for a vibrator signal. The multiplexer output is coupled to a corresponding power amplifier of the channel. The selection signal may be received, via a digital communications interface of the codec, from a central processing unit in the audio device that determines whether the specified channel in the audio codec chip is to drive a speaker or a vibrator through the same output pin. The audio codec chip may include additional audio channels and output pins.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows two portable audio devices, namely: a tablet computer and a mobile phone.

FIG. 2a shows an audio codec chip that is integrated within the tablet computer of FIG. 1.

FIG. 2b shows the audio codec chip of FIG. 2a integrated within the mobile phone of FIG. 1.

FIG. 3 is a diagram of some of the components of the audio codec chip of FIGS. 2a and 2b.

FIG. 4 shows a method for operating the audio codec chip of FIGS. 2a and 2b.

### DETAILED DESCRIPTION

Several embodiments of the invention with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

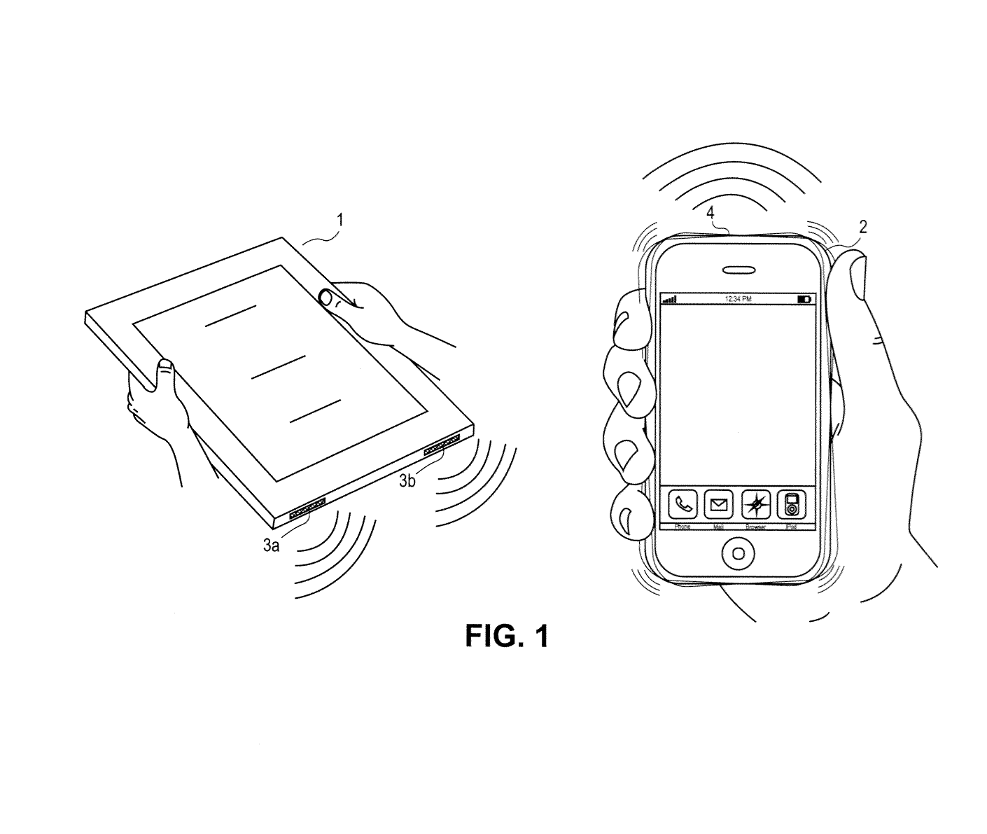

FIG. 1 shows two portable audio devices: a tablet computer 1 and a mobile phone 2. Although a tablet computer 1 and a mobile phone 2 are shown, the techniques, and in particular the audio codec, described here can alternatively be used in other audio devices including a portable music player, a laptop computer, a netbook computer, or even a desktop computer.

The tablet computer 1 may include a hardware processor, memory in which software that programs the processor is stored, a touch sensitive screen, an audio codec chip, and multiple speakers 3a and 3b. For example, the tablet computer 1 may be an iPad™ tablet computer designed by Apple Inc. of Cupertino, Calif.

The mobile phone 2 may include a hardware processor, memory having stored therein software that programs the processor, a touch sensitive screen, an audio codec chip, a speaker 4, and a vibrator. For example, the tablet computer 1 may be an iPhone™ mobile phone designed by Apple Inc.

As shown in FIG. 1, the tablet computer 1 uses the speakers 3a and 3b to operate in a stereophonic mode by emitting a different channel of audio through each speaker 3a and 3b. For example, a music player application or game running on the tablet computer 1 may emit two different channels of an audio source (e.g. a right channel and a left channel) through the speakers 3a and 3b. In contrast, the mobile phone 2 uses speaker 4 to operate in a monophonic mode by emitting a single channel of audio through the speaker 4. As also shown in FIG. 1, the mobile phone 2 is able to vibrate simultaneously, using an integrated vibrator.

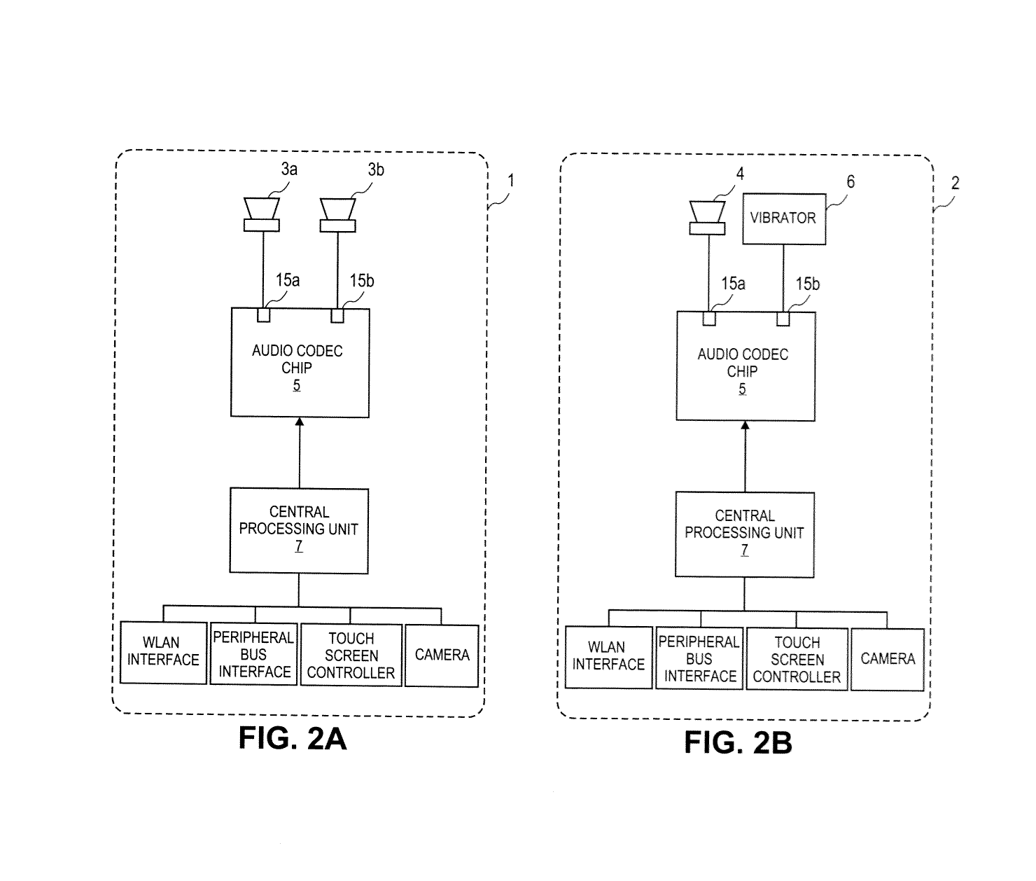

FIG. 2a shows an audio codec chip 5 that is integrated within the tablet computer 1. As described in further detail below, the audio codec chip 5 may be used to drive the speakers 3a and 3b in the tablet computer 1 in a stereophonic mode. FIG. 2b shows the audio codec chip 5 integrated within the mobile phone 2. As described in further detail below, the audio codec chip 5 may be used to drive the speaker 4 in a monophonic mode and a vibrator 6 integrated in the mobile phone 2. The vibrator may be a linear motor vibrator that receives a sinusoidal drive signal for example in the range 2.9 Hz-750 Hz.

As shown in both FIGS. 2a and 2b, the audio codec chip 5 may be driven and configured or programmed by output received from central processing unit 7. Central processing unit 7 may be a general-purpose microprocessor, an applications processor, or a system-on-chip (SoC) used to perform basic arithmetical, logical, and input/output operations in the portable audio devices 1 and 2. For example, the central processing unit 7 may be used to run applications on the tablet computer 1 and the mobile phone 2. The central processing unit 7 may also be connected to a WLAN processor, a computer peripheral bus interface, a touch screen controller, and a camera in both the tablet computer 1 and the mobile phone 2. In the case of a mobile phone, there is also a terrestrial cellular radio access network or mobile network radio transceiver and base band processor (not shown). The audio codec chip 5 will be described in greater detail below.

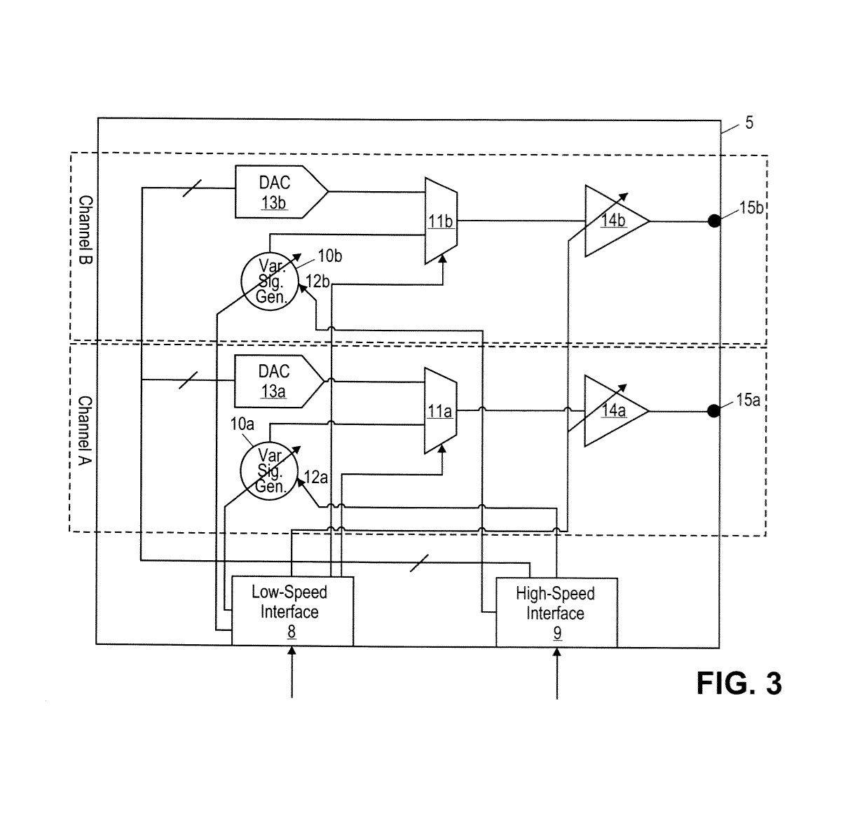

FIG. 3 is a diagram of some of the components of the audio codec chip 5. As shown in FIG. 3, the audio codec chip 5 includes a low-speed distal communications interface 8, a high-speed digital communications interface 9, variable signal generators 10a and 10b, multiplexers 11a and 11b, enable switches 12a and 12b, digital-to-analog converters (DACs) 13a and 13b, power amplifiers 14a and 14b, and pins 15a and 15b. Each of these elements will be described by way of example in the description that follows. The description that follows covers one channel of the audio codec chip 5. In particular, channel A as shown in FIG. 3 will be described. The audio codec chip 5 may include more channels configured similarly, to drive additional speakers and vibrators (e.g. Channel B in FIG. 3).

The low-speed interface 8 enable elements within the audio codec chip 5 to communicate with elements in the audio device external to the audio codec chip 5. For example, the low-speed interface 8 may be an Inter-Integrated Circuit (I²C) interface that allows the central processing unit 7 to configure or program components within the audio codec chip 5. In a mobile device that includes a vibrator, such as the mobile phone 2 that includes the vibrator 6, the low-speed interface 8 receives a vibrator frequency value. The low-speed interface 8 passes the frequency value to the variable signal generator 10a such that the variable signal generator 10a may produce a sinusoidal analog waveform at the specified frequency value. The variable signal generator 10a can produce the waveform continuously. In one embodiment, the variable signal generator 10a is capable of producing a sinusoidal waveform in the auditory frequency range (e.g., 2.9 Hz-750 Hz). The waveform produced by the variable signal generator 10a is fed to the multiplexer 11a.

Similar to the low-speed interface 8, the high-speed interface 9 enables communications between components within the audio codec chip 5 and components external to the audio codec chip 5. However, the high-speed interface 9 operates at a higher data rate than the low-speed interface 8 and can support the transfer of digital audio signals (digital audio bit streams). For example, the high-speed interface 9 may be an Integrated Interchip Sound (I²S) interface that enables audio transfers between the central processing unit 7 and components within the audio codec chip 5. High-speed interface 9 also receives a pulse-width modulation (PWM) signal that will drive an enable signal 12a to open and close or toggle on and off the output of the variable signal generator 10a. The PWM signal may be received from the central processing unit 7, and is used to “pulse” the sinusoidal waveform produced by the variable signal generator 10a (which is sent to an input pin of the multiplexer 11a). The on and off intervals of the PWM signal may emulate an event in an application running on the mobile phone 2. For example, the PWM signal may toggle every half-second and thereby emulate a character in a first-person-shooter (FPS) game (running on the mobile phone 2) being struck every half-second by a bullet. In another example, the PWM signal may be asserted briefly each time an email message has been received by a mail application (running on the mobile phone 2.)

The high-speed interface 9 may also receive a digital audio signal (from a source external to the audio codec chip 5.) In a stereophonic mobile audio device (e.g. the table computer 1), the digital audio signal includes multiple channels of audio (e.g. a left audio channel and a right audio channel). In a monophonic mobile audio device (e.g. the mobile phone 2), the digital audio signal includes a single channel of audio. The digital audio signal may be a music/audio stream originating from an audio application running on the central processing unit 7, a downlink audio communications signal originating from a baseband processor or the WLAN interface, or any another audio signal (e.g., a music or movie file streaming from a remote server over the Internet).

One channel of the digital audio signal is output from the high-speed interface 9 to the DAC 13a. As explained above, other channels in the digital audio signal may be output to other DACs in other channels of the audio codec chip 5 (e.g. the DAC 13b). In the case where the digital audio signal includes only one channel of audio, the single audio channel is output to DAC 13a while nothing may be output to the other DAC 13b. The audio signal received by the DAC 13a may have gone through several processing stages (not shown) such as automatic gain control, equalization, active noise cancellation, and mixing/effects, prior to being received by the DAC 13a.

The DAC 13a converts the received digital audio signal into analog form. The analog signal produced by DAC 13a is fed to an input of the multiplexer 11a. The multiplexer 11a may selectively output either the variable signal generator waveform or the analog audio signal. The determination on which signal to output is made by a selection signal provided by the low-speed interface 8 and received by the multiplexer 11a through a control input.

The selection signal output by the low-speed interface 8 may indicate whether the audio codec chip 5 is operating in a monophonic mode or a stereophonic mode. For example, the selection signal indicates the audio codec chip 5 is operating in a stereophonic mode when it configures the multiplexer 11a to output the analog audio signal originally output by the DACs 13a. In contrast, the selection signal indicates the audio codec chip 5 is operating in a monophonic mode when it configures the multiplexer 11a to output a vibrator waveform. Another selection signal may simultaneously configure the multiplexer lib in channel B to output an audio signal, in both monophonic mode and in stereo mode.

The output of the multiplexer 11a, regardless of mode and selection signals, is received by the power amplifier 14a. The power amplifier 14a amplifies the received signal (e.g. analog audio signal or vibrator waveform) to a level that is suitable for driving a speaker (volume setting) or a vibrator (vibration strength). The power amplifier 14a may receive control signals from the low-speed interface 8 for controlling the level of amplification performed on the received signal, i.e., a volume setting when the received signal is an audio signal, and a vibrator motor strength setting when the received signal is a waveform from the variable signal generator.

The output of the power amplifier 14a is connected to the pin 15a in the audio codec chip 5. The pin 15a allows the audio codec chip 5 to be directly connected to either a speaker or a vibrator motor such that channel A of the audio codec chip 5 may drive either a connected speaker or a vibrator (one at a time). The pin 15a may be a contact pad, a keyed or un-keyed connector contact, a plug contact or pin, or any other conductive terminal that connects to either a built-in or accessory speaker (e.g., via a speaker pin of a head phone jack) in one case, or a built-in vibrator in another case.

As described above, the codec chip 5 may selectively drive a pair of speakers simultaneously, or a speaker and a vibrator simultaneously, using separate audio channels of the audio codec chip 5 (e.g. channel A and channel B). Thus, the codec chip 5 may be used in a potable audio device that includes multiple built-in speakers and operates in stereophonic mode (e.g. the tablet computer 1) or it may alternately be used in a portable audio device that includes a single built-in speaker and a vibrator (e.g. the mobile phone 2), without wasting an audio channel in the codec chip 5.

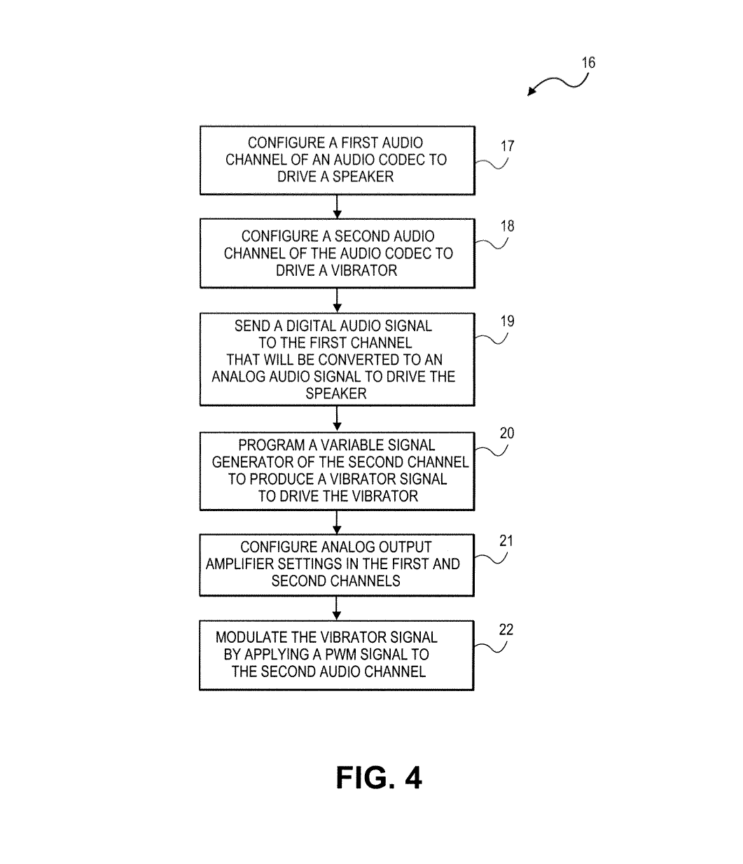

Turning now to FIG. 4, a method for configuring an audio codec chip to drive a speaker and a vibrator 16 will be described. Each operation in the method 16 may be performed by a programmed external processor (e.g., the central processing unit 7 of FIGS. 2a and 2b) that is communicating with one or more components of the codec chip 5 via the low speed and high speed interfaces 8, 9 described above and shown in FIGS. 2a, 2b and 3.

The method for configuring an audio codec chip to drive a speaker and a vibrator 16 begins at operation 17 with the configuration of a first audio channel of the audio codec to drive a speaker. The configuration of operation 17 may be performed by programming a selection control signal for an analog multiplexer in the first channel to select an output of a DAC. The DAC outputs an analog audio signal that may be used to drive the speaker.

Operation 18 configures a second audio channel of the audio codec to drive a vibrator. The configuration of operation 18 may be performed by programming a selection control signal to an analog multiplexer in the second channel to select an output of a variable signal generator, rather than an output of another DAC. The output of the variable signal generator may be a vibrator signal that may be used to drive the vibrator.

At operation 19, a digital audio signal is sent to the DAC of the first audio channel that will be converted to an analog form. This may be done by an external processor routing an audio downlink signal through a high-speed audio interface of the codec.

At operation 20, the variable signal generator is programmed to produce a vibrator signal that will drive the vibrator (through the second channel of the audio codec.) The vibrator signal may be generated based on a vibrator frequency value that may also be programmed by a source external o the audio codec chip.

At operation 21, the first and second channels of the audio codec chip are configured to amplify their respective analog multiplexer outputs. For example, power amplifiers in each channel may be programmed using control signals received from a source external to the audio codec chip.

At operation 22, the second audio channel is configured to modulate the vibrator signal. For example, an enable switch in the second audio channel may be programmed to toggle on and off based on a pulse width modulation signal that is sent to the codec from an external source. By modulating the vibrator signal, a pulsed or intermittent vibration of the vibrator is achieved. This may occur simultaneous with operation 19 in which the digital audio signal is being played through a speaker.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. An audio codec chip, comprising:
a first digital to analog converter (DAC) to receive a first digital audio signal from a source external to the codec chip;
a first variable signal generator;
a first multiplexer coupled to the first DAC to receive a first analog audio signal and coupled to the first variable signal generator to receive a first vibrator signal;
an external communications interface coupled to a control input of the first multiplexer, to deliver a first selection signal that configures the first multiplexer to route either the first analog audio signal or the first vibrator signal, not both simultaneously, through a first output pin of the audio codec chip; and
a first power amplifier having an input coupled to an output of the first multiplexer, and an output coupled to the first output pin of the codec chip.

2. The audio codec chip of claim 1, further comprising:
a further external communications interface to receive a control signal from a source external to the codec chip,
wherein the first variable signal generator comprises an enable input to turn on and turn off the vibrator signal, the enable input being coupled to the further external communications interface to receive the control signal,
wherein the external communications interface is to receive a vibrator frequency value from a source external to the codec chip and in response provide the frequency value to configure the first variable signal generator.

3. The audio codec chip of claim 2, wherein the external communications interface is a low-speed interface, and wherein the further external communications interface is a high-speed interface.

4. The audio codec chip of claim 1, further comprising:
a second DAC;
a second variable signal generator;
a second multiplexer coupled to the second DAC to receive a second analog audio signal and coupled to the second variable signal generator;
the external communications interface coupled to a control input of the second multiplexer, to deliver a second selection signal that configures the second multiplexer to route either the second analog audio signal or an output signal of the second variable signal generator, not both simultaneously, through a second output pin of the audio codec chip; and
a second power amplifier having an input coupled to an output of the second multiplexer, and an output coupled to the second output pin of the codec chip.

5. An audio device, comprising:
a first speaker; and
an audio codec chip having a first audio channel coupled to a first output pin, the first speaker being coupled to the first output pin, and a second audio channel coupled to a second output pin, the second audio channel having a multiplexer for selectively outputting one of an audio signal and a vibrator signal to the second output pin; and
a first interface for transmitting a selection signal to the multiplexer, wherein the selection signal configures the multiplexer to alternately output one of the audio signal and the vibrator signal.

6. The audio device of claim 5, wherein the selection signal indicates the portable electronic device is operating in (i) stereo mode when the multiplexer is configured to output the audio signal, and (ii) monophonic mode when the multiplexer is configured to output the vibrator signal.

7. The audio device of claim 6, wherein the multiplexer outputs the audio signal in response to the selection signal indicating the portable electronic device is operating in stereo mode.

8. The audio device of claim 6, wherein the multiplexer outputs the vibrator signal in response to the selection signal indicating the portable electronic device is operating in monophonic mode.

9. The audio device of claim 6, further comprising a second speaker coupled to the second output pin of the codec, the codec being configured for stereo mode with the first interface being programmed to configure the multiplexer to output the audio signal.

10. The audio device of claim 5, wherein the audio codec chip further comprises:
a variable signal generator for generating the vibrator signal based on a vibrator frequency, the vibrator frequency received by the variable signal generator through the first interface; and
a second interface for receiving a modulation signal for modulating the output of the variable signal generator.

11. The audio device of claim 6, further comprising a vibrator coupled to the second output pin of the codec, the codec being configured for monophonic mode with the first interface being programmed to configure the multiplexer to output the vibrator signal.

12. A process for configuring an audio codec, comprising:
configuring a first audio channel of the audio codec to drive a speaker by programming a selection control signal for an analog multiplexer in the first channel to select an output of a DAC;
configuring a second audio channel of the codec to drive a vibrator, by programming a selection control signal to an analog multiplexer in the second channel to select an output of a variable signal generator;
sending a digital audio stream to an input of the DAC; and
programming the variable signal generator to produce a vibrator signal,
wherein the audio codec produces sound through the speaker while simultaneously driving the vibrator.

13. The process for configuring the audio codec of claim 12, further comprising:
configuring the first audio channel o amplify output of the multiplexer according to a volume setting.

14. The process for configuring the audio codec of claim 2, further comprising:
sending a pulse width modulation signal to an enable input of the variable signal generator, to modulate the vibrator signal.

15. The process for configuring the audio codec of claim 14, wherein the pulse width modulation signal is sent to a high-speed interface of the codec, while the programming of the variable signal generator and the multiplexer selection signal was sent through a low-speed interface of the codec.

16. The process for configuring the audio codec of claim 13, further comprising:
configuring the second audio channel to amplify output of the multiplexer according to a vibration strength.
